(19) United States
(12) Patent Application Publication
(10) Pub. No.: US 2017/0353799 A1
(43) Pub. Date: Dec. 7, 2017

(54) Mobile Terminal

(71) Applicant: ZTE CORPORATION, Shenzhen City, Guangdong Province (CN)

(72) Inventor: Jiaxun SUN, Shenzhen (CN)

(21) Appl. No.: 15/328,492

(22) PCT Filed: Oct. 15, 2014
(86) PCT No.: PCT/CN2014/088667

§ 371 Date: Jun. 13, 2017

(30) Foreign Application Priority Data
Jul. 29, 2014 (CN) 201420423563.7

(51) Int. Cl. H04R 5/04; G10L 19/00; H04R 3/00

(52) U.S. Cl. CPC H04R 5/04; H04R 3/00; G10L 19/00; H04R 2420/05; H04R 2420/03

(57) ABSTRACT

A mobile terminal in embodiments of the present disclosure includes a compatible circuit connected with an earphone socket, which includes: the earphone socket having input and output pins; a CODEC chip connected with earphone socket input pins determining an external device inserted into the earphone socket according to an impedance value of earphone socket input pins; an AP chip connected with CODEC chip; and an analog switch chip connected with AP chip, output pins of which are connected with earphone socket output pins, and input pins of which are connected with speaker signal output pins and earphone signal output pins of CODEC chip respectively. When the external device is an external speaker, AP chip controls the analog switch chip to output a speaker output signal, output by the CODEC, via output ports of the analog switch; when an earphone, output an earphone signal via output ports of the analog switch.

### TECHNICAL FIELD

The present disclosure relates to the field of communication technology, and in particular to a mobile terminal.

### BACKGROUND

With the rapid development of the science and technology, using a mobile terminal to play music and movies has become a very important way of entertainment in people's daily life. The user also has increasingly higher requirements for mobile terminal functions especially for speaker sound volume and tone quality aspects.

Fort the mobile terminal, major factors affecting the play volume and tone quality are the performance of a speaker unit and the size of a speaker audio cavity. Since acoustical power radiated by the speaker of the mobile terminal is relatively high, it is impossible to make the volume of the speaker unit extremely small. Meanwhile, the volume of the speaker cavity greatly affects the sound loudness and tone quality of the speaker. The more regular the speaker cavity is, the bigger the back cavity is, and the richer the low-frequency parts of sounds played by the speaker is, thus the tone quality will be relatively better. On the contrary, the smaller the back cavity of the speaker is, the less the low-frequency components of the sounds played is, thus the sounds will be relatively uninteresting, monotonous and lack of strength.

Paradoxically, the current smart mobile terminal market increasingly advocates a thinner type, and space left to the speaker cavity becomes less, and the promotion of the sound quality entirely depending on algorithms has no much space. If it is to pursue good speaker tone quality, a large speaker SPK cavity volume and a high-performance speaker unit will be certainly needed. The thickness of the speaker unit commonly used in the mobile terminal is generally 3.5 mm at present, even though the speaker unit manufacturers also constantly optimize the thickness of the speaker, so far the thickness is still above 2.5 mm at least. A speaker with such thick is placed within a housing of the mobile terminal, and certain volume of front and back cavities is still needed, and the thickness of the screen and main board is superadded, thus it will certainly be very difficult to make it ultrathin.

### SUMMARY

The embodiments of the present disclosure provide a mobile terminal, to solve the problem of poor tone quality of a speaker due to the fact that a speaker cavity of the existing mobile terminal is relatively small.

To achieve the above object, an embodiment of the present disclosure provides a mobile terminal including a housing. Herein, the housing is provided with an earphone socket and a compatible circuit connected with the earphone socket. Herein, the compatible circuit includes: an audio coder and decoder, an analog switch, an application processor and the earphone socket.

The earphone socket has input pins and output pins.

The audio coder and decoder is connected with the input pins of the earphone socket, and determines an external device inserted into the earphone socket according to an impedance value detected at an input pin of the earphone socket, and the external device includes an external speaker and an earphone.

Output pins of the analog switch are connected with the output pins of the earphone socket, and input pins of the analog switch are connected with speaker signal output pins of the audio coder and decoder and earphone signal output pins of the audio coder and decoder respectively.

The application processor is connected with the audio coder and decoder and the analog switch, and when the external device is the external speaker, the application processor controls the analog switch to output an input signal from the speaker signal output pins of the audio coder and decoder via the output pins of the analog switch; and when the external device is the earphone, the application processor controls the analog switch to output an input signal from the earphone signal output pins of the audio coder and decoder via the output pins of the analog switch.

Herein, the input pins of the earphone socket include an MIC pin and a DET pin.

The audio coder and decoder includes an HPdet pin and an HPmic pin.

Herein, the HPdet pin is connected with the DET pin, and detects the impedance value of the input pins of the earphone socket, and determines the external device inserted into the earphone socket. The MIC pin is connected with the HPmic pin.

Herein, the output pins of the earphone socket include a right channel pin and a left channel pin.

The output pins of the analog switch include a first output pin and a second output pin.

Herein, the first output pin is connected with the right channel pin, and the second output pin is connected with the left channel pin.

Herein, the analog switch includes a control line pin.

The control line pin is connected with a GPIO pin of the application processor.

When the external device is the external speaker, the application processor controls input signals of a first analog signal input port and a second analog signal input port of the analog switch to be output respectively via a first analog signal output port and a second analog signal output port through the control line pin.

When the external device is the earphone, the application processor controls input signals of a third analog signal input port and a fourth analog signal input port of the analog switch to be output respectively via the first analog signal output port and the second analog signal output port through the control line pin.

Herein, the first analog signal input port and the second analog signal input port of the analog switch are respectively connected with an SPKN pin and an SPKP pin of the audio coder and decoder; and

the third analog signal input port and the fourth analog signal input port of the analog switch are respectively connected with an HPR pin and an HPL pin of the audio coder and decoder.

The mobile terminal further includes a power amplifier. Herein, two input ends of the power amplifier are respectively connected with the SPKN pin and the SPKP pin of the audio coder and decoder, and two output ends of the power amplifier are respectively connected with the first analog signal input port and the second analog signal input port of the analog switch.

Herein, the earphone socket, the audio coder and decoder and the analog switch all have one ground pin.

Herein, the external speaker includes:

an external speaker box; and

a speaker box plug connected with the external speaker box and the earphone socket on the housing.

Herein, the speaker box plug includes a first touch point and a second touch point. Herein, the first touch point is respectively connected with a left channel pin and a DET pin of the earphone socket; and the second touch point is respectively connected with a right channel pin, an MIC pin and a ground pin of the earphone socket.

Herein, the first touch point and the second touch point are connected with two contacts of the external speaker box through conducting wires.

Herein, the speaker box plug is a two-section plug, and the first touch point is located on a first section where the speaker box plug is closed to an earphone socket port, and the second touch point is located on a second section where the speaker box plug is far from the earphone socket port.

The embodiments of the present disclosure have the following beneficial effects:

The mobile terminal of the embodiments of the present disclosure determines the external device inserted into the earphone socket is the earphone or the external speaker according to the impedance value of the input pins of the earphone socket, to perform a switch between an earphone play mode and an external speaker play mode. Therefore, the mobile terminal of the embodiments of the present disclosure achieves a high-performance speaker effect and improves the speaker volume and user experience.

### BRIEF DESCRIPTION OF DRAWINGS

FIG. 1 is a diagram of a compatible circuit according to an embodiment of the present disclosure.

FIG. 2 is a structure diagram of an external speaker according to an embodiment of the present disclosure.

FIG. 3 is a work flowchart according to an embodiment of the present disclosure.

### DESCRIPTION FOR DRAWING REFERENCE NUMBERS

1—External speaker, 2—Speaker box plug, 3—External speaker box.

### DETAILED DESCRIPTION

To make the technical problem solved in the embodiments of the present disclosure, the technical scheme and the advantages more clear, detailed descriptions will be made in combination with the specific embodiments and accompanying drawings below.

The embodiments of the present disclosure solve the problem of poor tone quality of a speaker due to the fact that a speaker cavity of the existing mobile terminal is relatively small. An embodiment of the present disclosure provides a mobile terminal including a housing, and the housing is provided with an earphone socket. The mobile terminal also includes:

a compatible circuit connected with the earphone socket, herein, as shown in FIG. 1, the compatible circuit includes the earphone socket, an audio coder and decoder CODEC chip, an application processor AP chip and an analog switch chip.

The earphone socket has input pins and an output pins. The input pins of the earphone socket include an MIC pin and a DET pin. The output pins of the earphone socket include a right channel RIGHT pin and a left channel LEFT pin. The earphone socket also includes one ground pin GND.

The audio coder and decoder chip is connected with the input pins of the earphone socket. The audio coder and decoder chip determines an external device inserted into the earphone socket according to an impedance value of the input pins of the earphone socket. The external device is an external speaker or an earphone. Herein, the audio coder and decoder chip includes: an HPdet pin, an HPmic pin, an HPL pin, an HPR pin, an SPKP pin and an SPKN pin.

In a specific embodiment of the present disclosure, the DET pin of the earphone socket detects the impedance value of the input pins of the earphone socket and determines the external device inserted into the earphone socket. The DET pin is connected with the HPdet pin of the audio coder and decoder chip. The MIC pin of the earphone socket is connected with the HPmic pin of the audio coder and decoder chip.

The application processor AP chip is connected with the audio coder and decoder chip. Specifically, the audio coder and decoder chip and the application processor chip are connected via a bus, and may mutually transmit control signals and data streams.

The analog switch chip is connected with the application processor chip. Input pins of the analog switch chip include four analog signal input ports IN1˜IN4. Herein, a first analog signal input port IN1 and a second analog signal input port IN2 are respectively connected with a speaker signal output end SPKN and a speaker signal output end SPKP of the audio coder and decoder chip; a third analog signal input port IN3 and a fourth analog signal input port IN4 are respectively connected with earphone signal output ends HPR and HPL of the audio coder and decoder chip. Output pins of the analog switch chip include: a first output pin OUT1 and a second output pin OUT2 respectively connected with the output pins of the earphone socket. In an exemplary embodiment, the first output pin OUT1 is connected with the right channel RIGHT pin of the earphone socket, and the second output pin OUT2 is connected with the left channel LEFT pin of the earphone socket.

In a specific embodiment of the present disclosure, the analog switch chip also includes a control line SELECT pin, and the analog switch chip is connected with a GPIO pin of the application processor chip via the SELECT pin. The application processor chip controls the IN1 and the IN2 of the analog switch chip to be respectively connected with the OUT1 and the OUT2 through the SELECT pin when the external device is the external speaker.

The application processor chip controls the IN3 and the IN4 of the analog switch chip to be respectively connected with the OUT1 and the OUT2 through the SELECT pin when the external device is the earphone.

In addition, in a specific embodiment of the present disclosure, a power amplifier such as a high-performance D type speaker power amplifier may also be added between the IN1 and IN2 of the analog switch and the SPKP pin and SPKN pin of the audio coder and decoder chip.

The compatible circuit of the embodiments of the present disclosure determines the external device inserted into the earphone socket is the earphone or the external speaker by detecting an impedance value of the external device, to perform a switch between an earphone play mode and an external speaker play mode, thereby achieving a high-performance speaker effect.

The working principle of the embodiments of the present disclosure will be illustrated below.

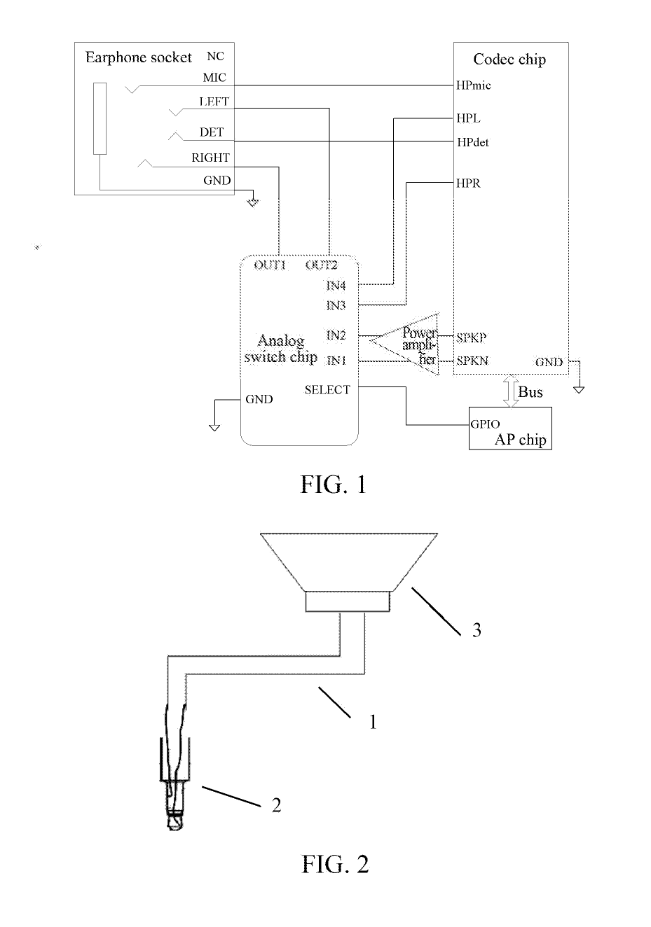

In a specific embodiment of the present disclosure, as shown in FIG. 2, an external speaker 1 includes: an external speaker box 3; and a speaker box plug 2 connected with the external speaker box 3 and the earphone socket on the housing of the mobile terminal. In an exemplary embodiment, the speaker box plug 2 is a two-section plug, and the speaker box plug 2 includes two touch points: a first touch point and a second touch point. The first touch point is located on a first section where the speaker box plug 2 is closed to the earphone socket. The second touch point is located on a second section where the speaker box plug 2 is far from the earphone socket. The two touch points are connected with two contacts of the external speaker box 3 through conducting wires. Therefore, sound analog electronic signals are connected into the two contacts of the external speaker box to drive the speaker to work and produce sounds.

At present, generally impedance values of speakers commonly used in the mobile terminals are all less than or equal to 8 ohms. When the speaker box plug 2 of the external speaker 1 is inserted into the earphone socket, one touch point at the top end of the speaker box plug 2 is connected with the DET pin and the left channel LEFT pin of the earphone socket, and the other touch point of the speaker box plug 2 is connected with the MIC pin, the right channel LEFT pin and the GND pin of the earphone socket. Since the DET pin of the earphone socket is connected with the HPdet pin of the audio coder and decoder chip, a resistance value detected by the HPdet pin of the CODEC chip is a resistance value between the two contacts of the speaker unit in the external speaker box or an impedance of the left channel of the earphone. If it is the external speaker box, the resistance value between the two contacts of the speaker unit is an impedance value to ground of the speaker unit, and the impedance value is less than or equal to 8 ohms. If it is the earphone, impedances to ground of left and right channels of the earphone are generally 32 ohms and not less than 16 ohms at the least. Thus the CODEC chip may distinguish the external device inserted into the earphone socket is the external speaker or the earphone according to the impedance value detected by the HPdet pin.

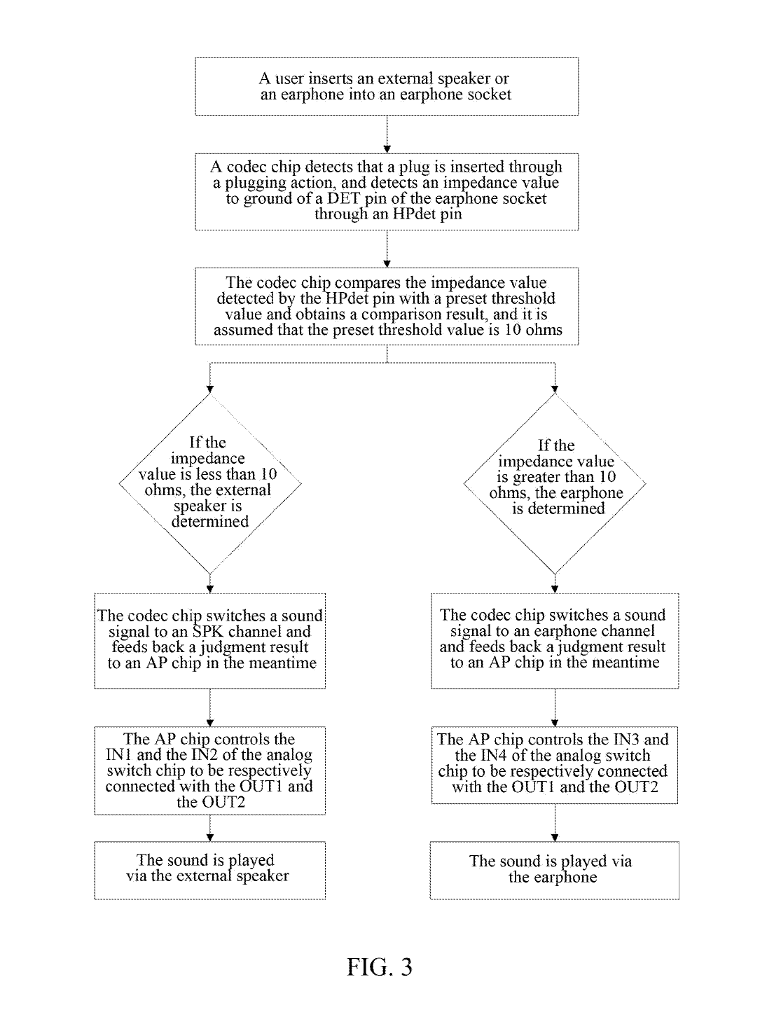

The work flow of the embodiment of the present disclosure is as shown in FIG. 3. A user inserts an external speaker or an earphone into an earphone socket.

A CODEC chip detects that a plug is inserted through a plugging action, and detects an impedance value to ground of an input pin DET of the earphone socket through an HPdet pin.

The CODEC chip compares the impedance value detected by the HPdet pin with a preset threshold value, and obtains a comparison result. It is assumed that the preset threshold value is 10 ohms.

When the comparison result is that the impedance value is less than 10 ohms, it is determined that the external device inserted into the earphone socket is the external speaker. When the comparison result is that the detected impedance value is greater than 10 ohms, it is determined that the external device inserted into the earphone socket is the earphone.

If the external device inserted into the earphone socket is the external speaker, the CODEC chip switches a sound signal to a speaker channel, namely, outputs the sound signal from the SPKP pin and the SPKN pin of the CODEC chip, and feeds back a judgment result to an AP chip in the meantime. If the external device inserted into the earphone socket is the earphone, the CODEC chip switches a sound signal to an earphone channel, namely, outputs the sound signal from the HPL pin and the HPR pin of the CODEC chip, and feeds back a judgment result to the AP chip in the meantime.

When the judgment result fed back by the CODEC chip is that the external device inserted into the earphone socket is the external speaker, the AP chip controls the OUT1 and the OUT2 of the analog switch chip to be respectively connected with the IN1 and the IN2 via the SELECT pin of the analog switch through a GPIO control line, and at this point, the sound signal is converted via the analog switch chip and played via the external speaker. When the judgment result fed back by the CODEC chip is that the external device inserted into the earphone socket is the earphone, the AP chip controls the OUT1 and the OUT2 of the analog switch chip to be respectively connected with the IN3 and the IN4 via the SELECT pin of the analog switch through the GPIO control line, and at this point, the sound signal is converted via the analog switch chip and played via the earphone.

The mobile terminal of the embodiments of the present disclosure judges the external device inserted into the earphone socket is the earphone or the external speaker by detecting the impedance value of the external device inserted into the earphone socket, thereby implementing the switch between an earphone play mode and an external speaker play mode. Therefore, a high-performance speaker effect is achieved, and the speaker volume is increased.

In a specific embodiment of the present disclosure, various types of speaker box cavities may be designed according to different mobile terminal shapes, thus the users have more choices. Meanwhile, the speaker box unit may also be freely rotated and disassembled, and may freely choose a sound transmission direction, thereby enhancing the user experience.

In the mobile terminal of the embodiments of the present disclosure, if a speaker mode is required, the external speaker is inserted into the earphone socket; and if the speaker mode is not required, it automatically switches to a vibrating mode.

The mobile terminal of the embodiments of the present disclosure achieves a high-performance speaker effect with the existing earphone socket, and effectively avoids layout limitations of the speaker and the speaker cavity on the mobile terminal in the meantime. Therefore, the mobile terminal of the embodiments of the present disclosure has a very strong application value and an improved user experience.

The above description is only the alternative embodiments of the present disclosure, and is not used to limit the present disclosure. All the modifications, equivalent substitutions, and improvements, etc. made within the essence and principle of the present disclosure shall be contained within the protection scope of the present disclosure.

### INDUSTRIAL APPLICABILITY

The mobile terminal of the embodiments of the present disclosure judges an external device inserted into an earphone socket is an earphone or an external speaker by detecting an impedance value of the external device inserted into the earphone socket, thereby implementing the switch between an earphone play mode and an external speaker play mode. Therefore, the mobile terminal of the embodiments of the present disclosure achieves a high-performance speaker effect and increases the speaker volume.

What we claim is:

1. A mobile terminal, comprising a housing, wherein the housing is provided with an earphone socket and a compatible circuit connected with the earphone socket; and the compatible circuit comprises: an audio coder and decoder, an analog switch, an application processor and the earphone socket; wherein, the earphone socket has input pins and output pins;
the audio coder and decoder is connected with the input pins of the earphone socket, and determines an external device inserted into the earphone socket according to an impedance value detected at an input pin of the earphone socket; and the external device comprises an external speaker and an earphone;
output pins of the analog switch are connected with the output pins of the earphone socket, and input pins of the analog switch are connected with speaker signal output pins of the audio coder and decoder and earphone signal output pins of the audio coder and decoder respectively; and
the application processor is connected with the audio coder and decoder and the analog switch, and when the external device is the external speaker, the application processor controls the analog switch to output an input signal from the speaker signal output pins of the audio coder and decoder via the output pins of the analog switch; and when the external device is the earphone, the application processor controls the analog switch to output an input signal from the earphone signal output pins of the audio coder and decoder via the output pins of the analog switch.

2. The mobile terminal according to claim 1, wherein, the input pins of the earphone socket comprise an MIC pin and a DET pin; input pins of the audio coder and decoder comprise an HPdet pin and an HPmic pin;
wherein, the HPdet pin is connected with the DET pin, and detects the impedance value of the input pins of the earphone socket, and determines the external device inserted into the earphone socket; and the MIC pin is connected with the HPmic pin.

3. The mobile terminal according to claim 1, wherein,
the output pins of the earphone socket comprise a right channel pin and a left channel pin;
the output pins of the analog switch comprise a first output pin and a second output pin;
wherein, the first output pin is connected with the right channel pin, and the second output pin is connected with the left channel pin.

4. The mobile terminal according to claim 1, wherein, the analog switch comprises:
a control line pin connected with a GPIO pin of the application processor; and wherein,
when the external device is the external speaker, the application processor controls input signals of a first analog signal input port and a second analog signal input port of the analog switch to be output respectively via a first analog signal output port and a second analog signal output port through the control line pin;
when the external device is the earphone, the application processor controls input signals of a third analog signal input port and a fourth analog signal input port of the analog switch to be output respectively via the first analog signal output port and the second analog signal output port through the control line pin.

5. The mobile terminal according to claim 4, wherein,
the first analog signal input port and the second analog signal input port of the analog switch are respectively connected with an SPKN pin and an SPKP pin of the audio coder and decoder; and
the third analog signal input port and the fourth analog signal input port of the analog switch are respectively connected with an HPR pin and an HPL pin of the audio coder and decoder.

6. The mobile terminal according to claim 5, further comprising a power amplifier, wherein two input ends of the power amplifier are respectively connected with the SPKN pin and the SPKP pin of the audio coder and decoder, and two output ends of the power amplifier are respectively connected with the first analog signal input port and the second analog signal input port of the analog switch.

7. The mobile terminal according to claim 1, wherein, the earphone socket, the audio coder and decoder and the analog switch all have one ground pin.

8. The mobile terminal according to claim 1, wherein, the external speaker comprises:
an external speaker box; and
a speaker box plug connected with the external speaker box and the earphone socket on the housing.

9. The mobile terminal according to claim 8, wherein, the speaker box plug comprises a first touch point and a second touch point, wherein, the first touch point is respectively connected with a left channel pin and a DET pin of the earphone socket; and the second touch point is respectively connected with a right channel pin, an MIC pin and a ground pin of the earphone socket.

10. The mobile terminal according to claim 9, wherein, the first touch point and the second touch point are connected with two contacts of the external speaker box through conducting wires.

11. The mobile terminal according to claim 8, wherein, the speaker box plug is a two-section plug, and the first touch point is located on a first section where the speaker box plug is closed to an earphone socket port, and the second touch point is located on a second section where the speaker box plug is far from the earphone socket port.
